(19) United States
(12) Patent Application Publication
(10) Pub. No.: US 2007/0172226 A1
(43) Pub. Date: Jul. 26, 2007

(54) DIGITAL SINGLE-LENS REFLEX CAMERA

(75) Inventors: Masahiro Nakata, Saitama (JP); Tomohiko Kanzaki, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/626,565

(22) Filed: Jan. 24, 2007

(30) Foreign Application Priority Data
Jan. 25, 2006 (JP) 2006-016003

(51) Int. Cl. G03B 13/02

(52) U.S. Cl. 396/374

(57) ABSTRACT

A digital single-lens reflex camera with preview functionality is provided that includes an imaging device, a monitor, and a preview image display processor. The imaging device captures an image through a photographing lens. The monitor displays the image captured by the imaging device. The preview image display processor displays the preview image captured by the imaging device on a monitor.

### BACKGROUND OF THE INVENTION

1. Field of the Invention

The present invention relates to a digital single-lens reflex camera that uses an imaging device to capture object images and store them as electronic data. In particular, the present invention relates to a digital single-lens reflex camera with preview functionality.

2. Description of the Related Art

A single-lens reflex camera is generally provided with preview functionality for a user to check exposure and depth of field by observing a scene through a photographing lens at a preset f-number, before performing actual photography. Conventionally, when the preview function is performed, an aperture is stopped down to the preset f-number and light made incident onto the photographing lens is reflected by a mirror and projected onto a focusing screen, thus an image produced on the focusing screen is observed through the viewfinder.

### SUMMARY OF THE INVENTION

However, the projected image observed through the viewfinder is small and even dark when the f-number is large, so that it is difficult for the user to check the depth of field.

An object of the present invention is to improve the preview functionality of a digital single-lens reflex camera.

According to the present invention, a digital single-lens reflex camera with preview functionality is provided. The digital single-lens reflex camera includes an imaging device, a monitor, and a preview image display processor.

The imaging device captures an image through a photographing lens. The monitor displays the image captured by the imaging device. The preview image display processor displays a preview image captured by the imaging device on the monitor.

### BRIEF DESCRIPTION OF THE DRAWINGS

The objects and advantages of the present invention will be better understood from the following description, with reference to the accompanying drawings in which:

FIG. 1 is a block diagram illustrating the structures of an embodiment of a digital single-lens reflex camera;

FIG. 2 is a flowchart of the main processes;

FIG. 3 is a flowchart of a power-hold on loop (ph_on_loop) process;

FIGS. 4A and 4B are flowcharts of a preview operation; and

FIG. 5 is a flowchart of a preview image selecting process.

### DESCRIPTION OF THE PREFERRED EMBODIMENTS

The present invention is described below with reference to the embodiments shown in the drawings.

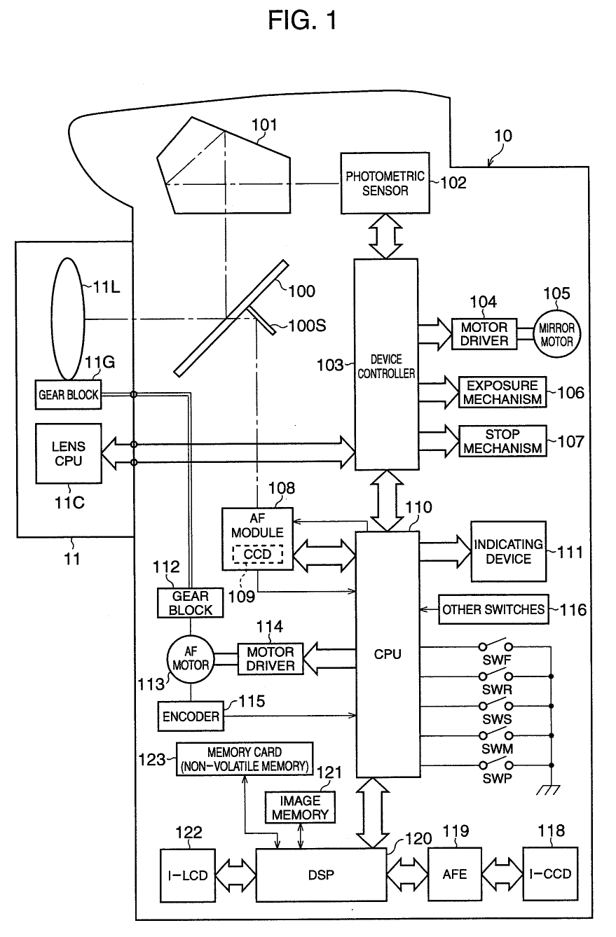

FIG. 1 is a block diagram that illustrates the structures of a digital single-lens reflex camera to which an embodiment of the present invention is applied. The camera is of a type that uses an interchangeable lens.

The digital single-lens reflex camera includes a camera body 10 and a lens barrel 11 attached on a lens mount of the camera body 10. The lens barrel 11 is provided with a photographing lens (a set of lenses) 11L, a gear block 11G for driving the photographing lens 11L, and a lens CPU 11C that communicates with the camera body 10 in order to transmit and receive lens-related information.

Light made incident on the photographing lens 11L is reflected by a mirror 100 inside the camera body 10 onto a focusing screen (not shown) so that an object image is produced on the focusing screen. The projected image on the focusing screen can be observed through a viewfinder (not shown) via a pentaprism 101. Further, portion of the light reflected by the mirror 100 is directed to a photometric sensor 102. The photometric sensor 102 is connected to a device controller 103 and a photometric value obtained by the photometric sensor 102 is used in an exposure control in accordance with a selected drive mode.

Further, a motor driver 104 for retracting the mirror 100 from the light path, an exposure mechanism 106 for driving a shutter (not shown), and a stop mechanism 107 for stopping down an aperture to a preset aperture setting (preset f-number) are also connected to the device controller 103, so that drive operations of each mechanism are controlled by the device controller 103. Further, the device controller 103 is electrically connected to the lens CPU 11C inside the lens barrel 11, which is attached to the camera body 10, so that the device controller 103 communicates with the lens CPU 11C and interactively transmits and receives information. Note that the device controller 103 is controlled by a CPU 110.

The mirror 100 is provided with a sub-mirror 100S. A portion of the light incident on the photographing lens 11L penetrates the mirror 100 and is reflected by the sub-mirror 100S. The reflected light is made incident onto a CCD 109 of an AF module 108, and is detected thereby. The AF module 108 provides autofocus functionality. Image information obtained by the CCD 109 is fed to the CPU 110 and the amount of defocus is calculated in order to carry out a focusing operation on the photographing lens. Namely, a motor driver 114 is controlled by the CPU 110 so that an AF motor 113, connected to a gear block 112 inside the camera body, is driven. The gear block 112 is connected via an AF coupler (not shown) to the gear block 11G that is located inside the lens barrel 11, thus the photographing lens 11L is driven. Further, an encoder 115 detects the amount that the AF motor 113 is driven, and feeds corresponding signals to the CPU 110.

An indicating device 111, such as an LCD, is also connected to the CPU 110. Various types of information, such as the drive mode, the number of recordable images, and the battery status, are indicated on the indicating device 111 as letters, numerals, symbols, and the like. In addition, an autofocus switch SWF, a release switch SWR, a photometry-switch SWS, a main switch SWM, a preview switch SWP, and other switches 116, including an information switch, image selecting switches (four-way controller keys), a settlement switch (an OK button), and an electronic mode dial switch, are connected to the CPU 110. A user can carry out various types of desired operations, such as photometry, photography, mode selection, and image selection, by operating the switches.

The CPU 110 is driven in a sleep mode when batteries (not shown) are installed and the main switch SWM is OFF state. However, when the main switch SWM is turned on, electric power is supplied to the other circuits. When a shutter button (not shown) is half depressed while the main switch SWM is ON, the photometry switch SWS is turned on, so that photometry is carried out by using the photometric sensor 102. Further, the autofocus switch SWF is turned on and the AF module 108, the AF motor driver 114, the AF motor 113, and the encoder 115 are driven so as to perform autofocusing operations.

Further, when the shutter button is fully depressed, the release switch SWR is turned on, so that the mirror 100 is retracted from the light path and the exposure mechanism 106 and the stop mechanism 107 are both driven. Namely, the light passing through the photographing lens 11L is made incident onto an imaging device 118, such as a CCD (I-CCD), to capture an object image at preset f-number and shutter speed. Image signals obtained by the imaging device 118 are subjected to predetermined signal processing by an analog front end circuit (AFE) 119, converted to digital signals, then fed to a digital signal processor (DSP) 120 before being stored in an image memory (RAM) 121 as image data. The image data is stored in a non-volatile memory 123, such as a memory card or the like. Further, the captured image can be displayed on an image-indicating device (I-LCD) 122, such as an LCD or the like, via the digital signal processor 120.

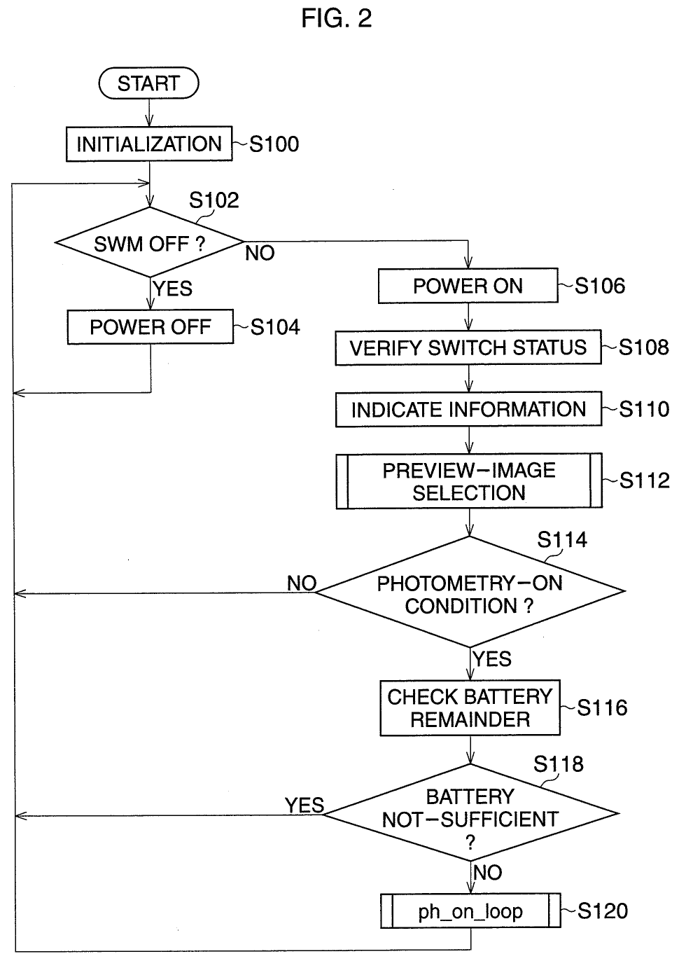

Referring to FIGS. 1 and 2, the main processes carried out by the digital single-lens reflex camera of the present embodiment will be explained. Note that FIG. 2 is a flowchart of the main processes.

When the batteries are installed in the camera body 10, the electric power is supplied to the CPU 110, and the main processes are performed. In Step S100, the CPU 110, including processor registers, I/O ports, an internal RAM, and so on, is initialized. Subsequently, in Step S102, a determination is made as to whether or not the main switch SWM is ON-state. When it is determined that the main switch SWM is not ON state, all of the circuits (e.g., the device controller 103 and DSP 120) other than the CPU 110 are maintained OFF-state, or switched from ON-state to OFF-state in Step S104, and the process then returns to Step S102. Namely, the camera is maintained in the sleep mode until the main switch SWM is turned on.

When it is determined in Step S102 that the main switch SWM is ON-state, electric power is supplied to all of the circuits in Step S106, including the device controller 103, the DSP 120, and so on, so that the system is released from the sleep mode and image capturing is enabled. In Step S108, a process for verifying the state of each switch is carried out. In Step S110, predetermined types of information such as the drive mode, the number of recordable images, and the battery status are indicated on the indicating device 111.

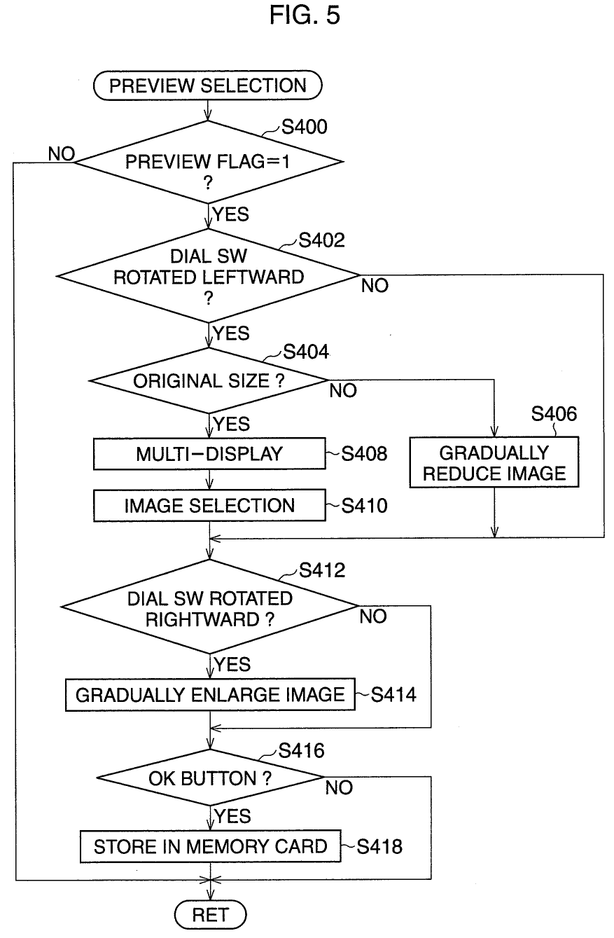

In Step S112, a process for selecting a preview image, which will be detailed later with reference to FIG. 5, is carried out. In Step S114, whether or not photometry is required is determined by whether the photometry-switch SWS or the preview switch SWP is switched on (photometry-ON conditions). When none of the photometry-ON conditions are satisfied, the process returns to Step S102 and the above-mentioned processes are repeated.

On the other hand, when it is determined in Step S114 that at least one of the photometry-ON conditions is satisfied, battery status is checked in Step S116, and the determination is made in Step S118 as to whether or not the remainder of the battery is sufficient for image capturing. When it is determined that the remainder is not sufficient, the process returns to Step S102.

On the other hand, when it is determined in Step S118 that the battery remainder is sufficient, a power-hold on loop (ph_on_loop) process, which will be detailed later, is carried out in Step S120. When this process is complete, the process returns to Step S102 and is repeated. The above-mentioned processes are the main routine of the present embodiment and this routine is carried out at all times as long as a battery or batteries are held in the camera body.

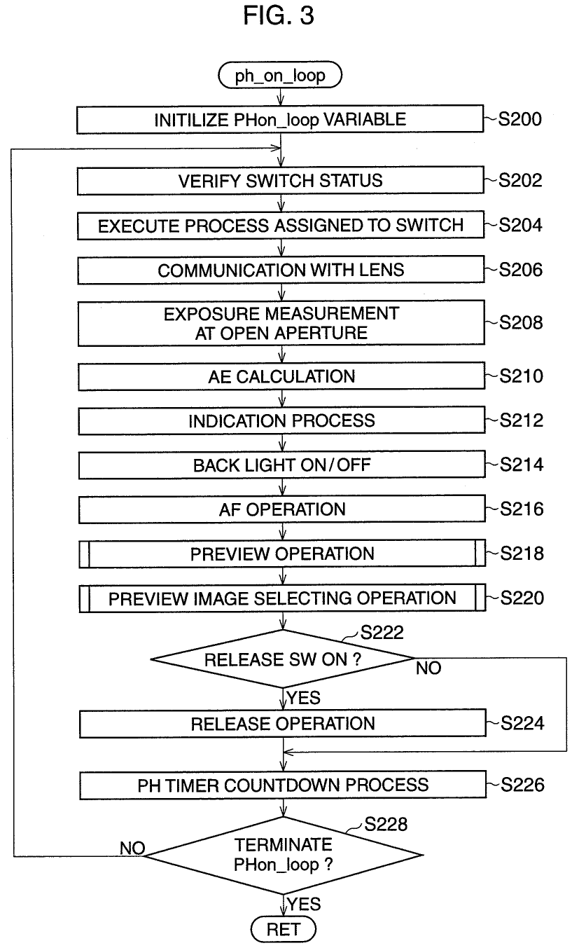

Next, with reference to the flowchart of the power-hold on loop (ph_on_loop) process of FIG. 3, which corresponds to Step S120 of FIG. 2, the power-hold on loop process of the present embodiment will be explained. As apparent from the flowchart of FIG. 2, the power-hold on loop process is performed when one of the photometry-ON conditions is satisfied and when the battery reminder is sufficient for the image capturing operation.

When the power-hold on loop process is started, a variable PHon_loop is initialized in Step S200. The variable PHon_loop is a counter variable for setting a time to continue the loop of the power-hold on loop process. Namely, the power-hold on loop process is terminated when the time preset by the variable PHon_loop elapses.

In Steps S202 and S204, the CPU 110 verifies the state of each switch and carries out a certain predetermined process assigned to each switch when the switch is ON-state. In Step S206, intercommunication between the camera body 10 and the lens barrel 11 is established, and the lens information, including a lens model number, a fully open aperture value, an f-number of maximum aperture, and a focal length, is input to the CPU 110. In Step S208, an exposure measurement at open aperture is performed by the photometric sensor 102 in order to obtain information about the brightness value Bv. In Step S210, the exposure value calculation (AE calculation) is carried out based on the brightness value By, ISO speed Sv, and so on, so that the shutter speed and an aperture value can be calculated. The calculated values of the shutter speed and the aperture value are indicated on the indicating device (LCD) 111 in Step S212, and a back light illumination of the indicating device 111 is turned on in Step S214.

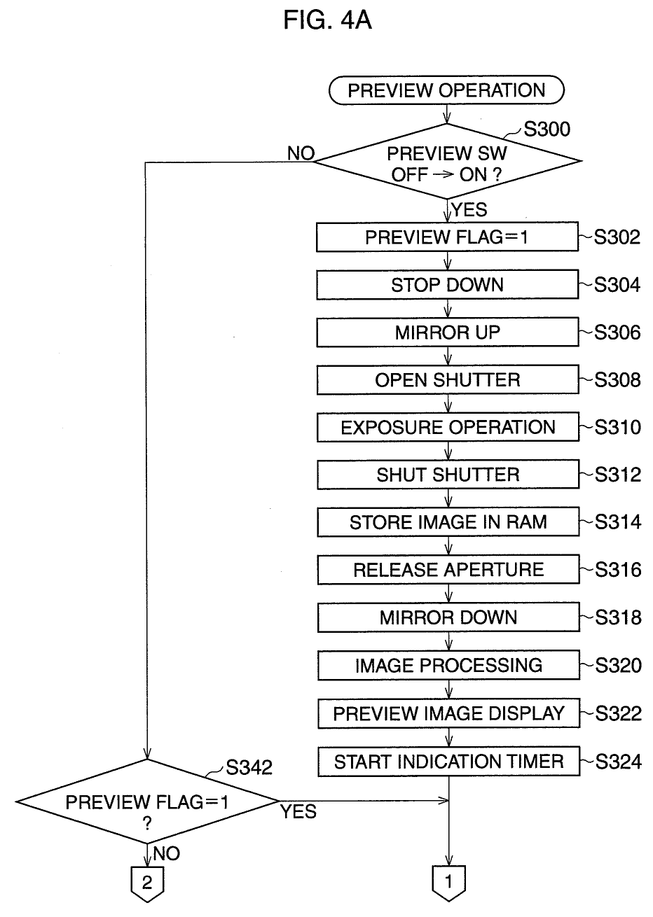

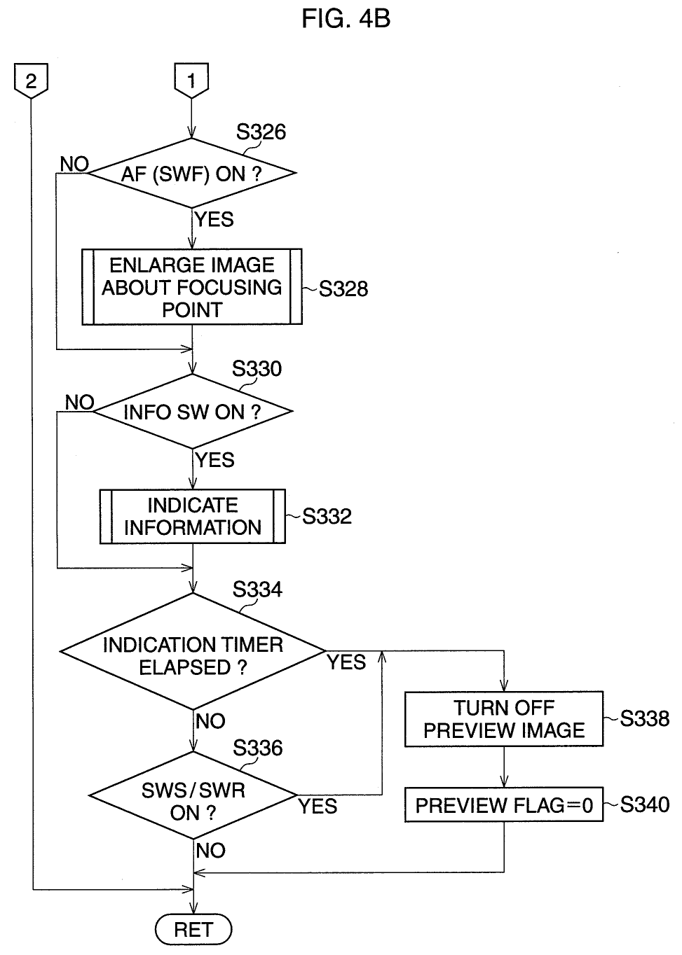

In Step S216, an auto focusing operation is performed by the AF module 108, the AF motor 113, the motor driver 114, and the encoder 115. The focusing operation is carried out by focusing upon one of a plurality of optional positions within view angles (e.g., focusing on the nearest position among the plurality of positions). In Step S218, a preview operation, which will be detailed later with reference to FIGS. 4A and 4B, is carried out. Further, in Step S220, a preview image selection operation, which will be detailed later with reference to FIG. 5, is performed for preview images, which are obtained by the preview operation in Step S218,

In Step S222, whether or not the release switch SWR is turned on, is determined. When the release switch SWR is turned on, a release operation, which is well known, is carried out in Step S224, so that an object image is captured by the imaging device (CCD) 118 and stored in the non-volatile memory 123, and then Step S226 is carried out. On the other hand, when it is determined in Step S222 that the release switch SWR is not turned on, Step S226 is immediately carried out.

In Step S226, a PH (power hold) timer countdown process is carried out. Namely, the PHon_loop variable is decreased by one or by some other predetermined value. In Step S228, determination is made whether or not to terminate the power hold on loop by determining whether or not the PHon_loop variable has reached a predetermined value. When the PHon_loop variable has not yet reached the predetermined value, thus determining not to terminate the power-hold on loop process, the process returns to Step S202 and the above-mentioned processes are repeated. On the other hand, when the PHon_loop variable has reached the predetermined value, thus determining to terminate the power-hold on loop process, the power_hold on loop process is terminated and the processes of the main routine (see FIG. 2), which follows Step S102, are repeated.

With reference to the flowchart of FIGS. 4A and 4B, the preview operation (Step S218 of FIG. 3) of the present embodiment will be explained. Note that FIG. 4A describes an earlier part of the preview operation and FIG. 4B describes a latter part of the operation.

The preview operation is started with the determination of whether the preview switch SWP has switched from OFF state to ON state in Step S300. When it is determined that the preview switch SWP has switched from OFF state to ON state, a preview flag is set to “1” in Step S302 and a preview image is obtained in Steps S302-S318.

Namely, the aperture is stopped down in Step S304, the mirror 100 is retracted from the light path in Step S306, and then the mechanical shutter is opened in Step S308. Further, in Step S310, an exposure operation (an image capturing operation) is carried out by the imaging device (CCD) 118. The mechanical shutter is closed in Step S312, and then in Step S314, the image data of the preview image, which is obtained by the imaging device (CCD) 118, is stored in the image memory (RAM) 121. In Step S316, the aperture is released, and in Step S318, the mirror 100 is returned to the light path.

Further, in Step S320, a white-balance process, an interpolation process, and so on, are carried out for the preview image. In Step S322, the preview image is displayed on the image-indicating device (I-LCD) 122, and in Step S324, an indication timer controlling the length of time for displaying the preview image is started.

In Step S326, whether or not the autofocus switch SWF has been turned on is determined. When it is determined that the autofocus switch SWF is On state, the preview image is enlarged around a position where the actual focusing was performed in the autofocus process (Step S216 of FIG. 3), and the process proceeds to Step S330. Namely, when the autofocus operating member is operated while the preview image is displayed on the image-indicating device (I-LCD) 122, the preview image is enlarged at the focusing point. On the other hand, when it is determined in Step S326 that the autofocus switch SWF is OFF state, the process immediately proceeds to Step S330.

In Step S330, whether an INFO switch (not shown) has been turned on is determined. When it is determined that the INFO switch is ON state, image information of the preview image is displayed on the image-indicating device (I-LCD) 122 in Step S332, and then the process proceeds to Step S334. Note that the INFO switch is an operational button which is normally used for indicating currently-selected modes on the image-indicating device (I-LCD) 122. However, when the INFO switch is operated while the preview image is being displayed, the image information of the displayed preview image, including a histogram of the preview image and saturated areas, is indicated. For example, the saturated areas are indicated by revising the color of corresponding pixels, by blinking the pixels, or by surrounding the area(s) with line(s). On the other hand, when it is determined in Step S330 that the INFO switch is OFF state, the process proceeds directly to Step S334.

In Step S334, whether the indication timer, which was started in Step S324, has reached its end value is determined. If the indication timer has not reached its end value, whether either the photometry-switch SWS or the release switch SWR has been turned on is determined. If neither of the switches is ON state, this preview operation ends.

On the other hand, when it is determined in Step S334 that the indication timer has reached the end value, or when it is determined in Step S336 that at least one of either the photometry-switch SWS or the release switch SWR has been turned on, then the illumination of the image-indicating device (I-LCD) 122 is turned off in Step S338 and the preview flag is set to “0” in Step S340, thus ending this preview operation.

Note that when it is determined in Step S300 that the preview switch SWP has not been switched from the OFF-state to the ON-state, whether the preview flag is equal to “1” is determined. Namely, whether or not the preview image is being displayed on the image-indicating device (I-LCD) 122 is determined.

When it is determined in Step S342 that the preview flag is equal to “1”, the process proceeds to Step S326 and the above-mentioned processes from Step S326 to Step S340 are carried out. On the other hand, when it is determined in Step S342 that the preview flag is not equal to “1”, this preview operation immediately ends.

Note that the preview switch SWP may be provided as an operational member separate from the release button. Further, during the preview operation, a preview image is stored in the image memory (RAM) 121 whenever the preview switch SWP is switched from the OFF-sate to the ON-state. Therefore, a plurality of preview images can be stored in the memory within the memory capacity.

Next, with reference to a flowchart of the preview image selecting process of FIG. 5, the process for selecting a preview image (Step S112 of FIG. 2 and Step S220 of FIG. 3) with the present embodiment will be explained.

When the preview image selection process is started, whether the preview flag is set to “1” is determined in Step S400. If the preview flag is not set to “1”, i.e. when the preview image has not been displayed, this preview image selection process immediately ends.

When it is determined in Step S400 that the preview flag is set to “1”, whether an electronic dial switch (not shown) has rotated in a leftward direction is determined in Step S402. When it is determined in Step S402 that the electronic dial switch has rotated in the leftward direction, whether the current preview image is displayed on the image-indicating device (I-LCD) 122 at its original size (100%) is determined in Step S404. If it is determined that the preview image is not displayed at its original size (if the preview image is enlarged), the size of the preview image is reduced gradually in Step S406 and then the process proceeds to Step S412.

On the other hand, when it is determined in Step S404 that the preview image is displayed at its original size, the plurality of preview images, which have been captured by the operation of the preview switch SWP and stored in the image memory (RAM) 121, are reduced and multi-displayed in Step S408. Further, in Step S410, the selection of one preview image among the plurality of preview images displayed on the image-indicating device (I-LCD) 122 is carried out using an image selection switch (a four-way cursor key). At the end of the preview image selection operation performed by the image selection switch, the process proceeds to Step S412.

On the other hand, when it is determined in Step S402 that the electronic dial switch has not rotated in the leftward direction, the process immediately proceeds to Step S412, where it is determined whether the electronic dial switch has rotated in a rightward direction. When it is determined in Step S412 that the electronic dial switch has rotated in the rightward direction, the preview image currently displayed on the image-indicating device (I-LCD) 122 is enlarged gradually in Step S414. Further, in Step S416, whether the settlement switch (OK button) has been turned on is determined. Note that, when it is determined in Step S416 that the electronic dial switch has not rotated in the rightward direction, the process immediately proceeds to Step S416 to determine whether the settlement switch (OK button) has been turned on.

When it is determined in Step S416 that the settlement switch (OK button) has been turned on, the currently displayed (selected) preview image is stored in a non-volatile memory 123 such as a memory card or the like, thus ending this preview image selection process. On the other hand, when it is determined in Step S416 that the settlement switch (OK button) has not turned on, this preview image selection process ends without storing the preview image in the non-volatile memory 123.

As described above, according to the present embodiment, the preview image that is conventionally viewed through the viewfinder can also be viewed on the monitor, so that the user can more easily carry out the preview operation. Further, since the preview image can be monitored on the screen, the user can check the exposure more precisely, and since the preview image can be enlarged, the user can check the depth of field more precisely.

Further, in the present embodiment, since the image information of the preview image can be displayed, validity of the exposure can also be checked not only from the observation of the preview image, but also with a histogram and the existence of saturation of the preview image. Further, in the present embodiment, since a plurality of preview images can be stored, preview images obtained under a plurality of photographing conditions can be compared before actual photographing takes place, thus making the selection of an appropriate photographing condition an easier process.

Furthermore, in the present embodiment, the preview image can be stored in the non-volatile memory, so that when the quality of an image obtained as the preview image is sufficient, the preview image can be recorded as the proper image, eliminating the need to capture the image again.

Note that in order to enable the preview selection in FIG. 2 (Step S112), the indicating timer described in FIGS. 4A and 4B is required to be preset longer than the timer (PHon_loop variable) for the power-hold on loop (Ph_on_loop), which is described in FIG. 3.

Further, in the indication of the image information of the preview image, the preview image, the preview image with the histogram superimposed thereto, and the preview image with the indication of saturation areas may be displayed cyclically, in turn, as the INFO switch is operated. Alternatively, the indication of the histogram or the saturated areas may be selected from a menu screen (not shown).

Note that the digital single-lens reflex camera of the present embodiment may also be provided with both the digital preview mode that displays the preview image obtained by the imaging device, and the optical preview mode where an optical image can be observed conventionally via the photographing lens through the viewfinder. Either mode may be selected from the menu screen by using the four-way controller keys and the OK button. Namely, when the digital preview mode is selected, the above-discussed preview operation and the preview image selection process are carried out and the preview image is obtained when the preview switch is operated. On the other hand, when the optical preview mode is selected, the stop value is stopped down to the conventional preset value and the image projected on the focusing screen is observable through the viewfinder.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2006-016003 (filed on Jan. 25, 2006) which is expressly incorporated herein, by reference, in its entirety.

1. A digital single-lens reflex camera provided with preview functionality, comprising:
a imaging device that captures an image through a photographing lens;
a monitor that displays the image captured by said imaging device; and
a preview image display processor that displays a preview image captured by said imaging device on a monitor.

2. A digital single-lens reflex camera according to claim 1, wherein said preview image display processor comprises an image enlarging processor that displays an enlarged version of the preview image on said monitor.

3. A digital single-lens reflex camera according to claim 2, further comprising an autofocus mechanism wherein said image enlarging processor enlarges the preview image around a position whereupon autofocus is performed.

4. A digital single-lens reflex camera according to claim 1, wherein said preview image display processor comprises an image information indication processor that indicates information relating to the preview image, on said monitor.

5. A digital single-lens reflex camera according to claim 1, wherein the information of said image information indication processor comprises at least one of a histogram of the preview image and a saturated area of the preview image.

6. A digital single-lens reflex camera according to claim 5, wherein said image information indication processor has the ability to superimpose said histogram on the preview image and to indicate said saturated area on the preview image; and has the ability to interchangeably display in turn, the preview image, the preview image superimposed with the histogram, and the preview image with the indication of the saturated area.

7. A digital single-lens reflex camera according to claim 1, further comprising the ability to store a plurality of preview images, and a preview image selection processor that is used to select a preview image to be displayed on said monitor from the plurality of preview images.

8. A digital single-lens reflex camera according to claim 1, further comprising an image storing processor that stores the preview image in a non-volatile memory.

9. A digital single-lens reflex camera according to claim 1, further comprising a mode switching device that switches between a digital preview mode and an optical preview mode, where said digital preview mode is a mode where the preview image is previewed on said monitor, and said optical preview mode is a mode where an optical image is previewed through said photographing lens.

10. A digital single-lens reflex camera according to claim 1, wherein said preview image display processor comprises a multi-display processor that displays multiple, reduced versions of a plurality of preview images on said monitor, and a preview image selection processor that is used to select a preview image to be displayed on said monitor from the plurality of preview images, which are multi-displayed on said monitor.
